(19) United States
(12) Patent Application Publication
(10) Pub. No.: US 2020/0408296 A1
(43) Pub. Date: Dec. 31, 2020

(54) METHOD AND DEVICE FOR ASSEMBLING SHAFT TO VEHICLE COMPONENT

(71) Applicants: Jeffrey Japinga, Waterford, MI (US); Ramesh Sadhneni, Troy, MI (US); Johnathon C. Robinson, Howell, MI (US)

(72) Inventors: Jeffrey Japinga, Waterford, MI (US); Ramesh Sadhneni, Troy, MI (US); Johnathon C. Robinson, Howell, MI (US)

(21) Appl. No.: 16/451,552

(22) Filed: Jun. 25, 2019

(51) Int. Cl. F16H 57/02; F16H 57/029; F16H 57/031

(52) U.S. Cl. CPC F16H 57/02; F16H 57/029; F16H 2057/0093; F16H 2057/02043; F16H 2057/02026; F16H 57/031

(57) ABSTRACT

A vehicle component including a casing and a cap. The casing defines an opening. The cap is removably coupled to the casing such that the cap plugs the opening. The cap including a membrane portion and a rim portion extending around the membrane portion. The cap is configured to be removed from the casing after a shaft is inserted through the membrane portion and at least partially through the opening.

### FIELD

The present disclosure relates to a method and a device for assembling a shaft to a vehicle component.

### BACKGROUND

This section provides background information related to the present disclosure and is not necessarily prior art.

Some vehicle components can be damaged in transit to an assembly plant and/or during assembly of a vehicle at the assembly plant. For example, a transmission is capped off at openings during shipment to the assembly plant. In this way, fluids and debris are prevented from entering into the transmission and fluid in the transmission is prevented from leaking out during shipment. The cap(s) are removed once the transmission is received at the assembly plant so that the transmission can be assembled to other vehicle components (e.g., axles). Assembling other vehicle components such as the axles to the transmission may cause damage to seals and other sub-components of the transmission.

The present disclosure provides a cap that prevents fluid and debris from entering into a vehicle component and fluid in the vehicle component from leaking out during shipment. The cap also protects sub-components (e.g., seals) of the vehicle component when assembling the vehicle component to other vehicle components.

### SUMMARY

This section provides a general summary of the disclosure, and is not a comprehensive disclosure of its full scope or all of its features.

In one form, the present disclosure provides a vehicle component including a casing and a cap. The casing defines an opening. The cap is removably coupled to the casing such that the cap plugs the opening. The cap including a membrane portion and a rim portion extending around the membrane portion. The cap is configured to be removed from the casing after a shaft is inserted through the membrane portion and at least partially through the opening.

In some configurations of the vehicle component of the above paragraph, the casing is a transmission casing. In other configurations, the casing is a differential casing. In other configurations, the casing is a transfer casing.

In some configurations of the vehicle component of any one or more of the above paragraphs, a sealing member is disposed between the cap and the casing.

In some configurations of the vehicle component of any one or more of the above paragraphs, the casing includes a cavity having fluid therein. The cap includes a hub extending from the rim portion toward the cavity.

In some configurations of the vehicle component of any one or more of the above paragraphs, the rim portion and the hub includes a slit formed therein.

In some configurations of the vehicle component of any one or more of the above paragraphs, the hub surrounds the membrane portion.

In some configurations of the vehicle component of any one or more of the above paragraphs, a sealing member is disposed between the hub and the casing.

In some configurations of the vehicle component of any one or more of the above paragraphs, the membrane portion includes a plurality of flexible tabs that are attached to each other prior to the shaft being inserted through the membrane portion and detached from each other after the shaft is inserted through the membrane portion.

In some configurations of the vehicle component of any one or more of the above paragraphs, the rim portion includes slit formed therein.

In some configurations of the vehicle component of any one or more of the above paragraphs, the cap includes a handle extending from the rim portion.

In another form, the present disclosure provides a method for assembling a shaft to a vehicle component. The method includes providing the vehicle component defining an opening, plugging the opening of the vehicle component with a cap, inserting the shaft through the membrane portion and at least partially through the opening, and removing the cap from the vehicle component after the shaft is inserted through the membrane portion and at least partially through the opening. The cap includes a membrane portion and a rim portion extending around the membrane portion.

In some configurations of the method of the above paragraph, the vehicle component includes a cavity having fluid therein. The cap includes a hub extending from the rim portion toward the cavity.

In some configurations of the method of the above paragraph, removing the cap from the vehicle component includes ripping the cap across the shaft.

In some configurations of the method of any one or more of the above paragraphs, the rim portion and the hub includes a slit formed therein.

In some configurations of the method of any one or more of the above paragraphs, a sealing member is disposed between the hub and the vehicle component prior to the cap being removed from the vehicle component.

In some configurations of the method of any one or more of the above paragraphs, the membrane portion includes a plurality of flexible tabs that are attached to each other prior to the shaft being inserted through the membrane portion and detached from each other after the shaft is inserted through the membrane portion.

In some configurations of the method of any one or more of the above paragraphs, the vehicle component is a transmission. In other configurations, the vehicle component is a differential. In other configurations, the vehicle component is a transfer casing.

In some configurations of the method of any one or more of the above paragraphs, a sealing member is disposed between the cap and the vehicle component prior to the cap being removed from the vehicle component.

In some configurations of the method of any one or more of the above paragraphs, the cap includes a handle extending from the rim portion.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a bottom view of a vehicle having a transmission and axle shafts assembled according to the principles of the present disclosure;

FIG. 2 is an exploded view showing one of the axles, a cap and the transmission of the vehicle;

FIG. 3 is a perspective view of the cap;

FIG. 4 is a perspective view of one of the axles being assembled to the transmission of the vehicle with the cap coupled to the transmission;

FIG. 5 is a perspective view of the one of the axles assembled to the transmission of the vehicle with the cap coupled to the transmission of the vehicle;

FIG. 6 is a partial cross-sectional view of the transmission taken along line 6-6 of FIG. 5;

FIG. 7 is a perspective view of the one of the axles assembled to the transmission of the vehicle with the cap removed from the transmission; and

FIG. 8 is a partial cross-sectional view of the transmission taken along line 8-8 of FIG. 7.

Corresponding reference numerals indicate corresponding parts throughout the several views of the drawings.

### DETAILED DESCRIPTION

Example embodiments will now be described more fully with reference to the accompanying drawings.

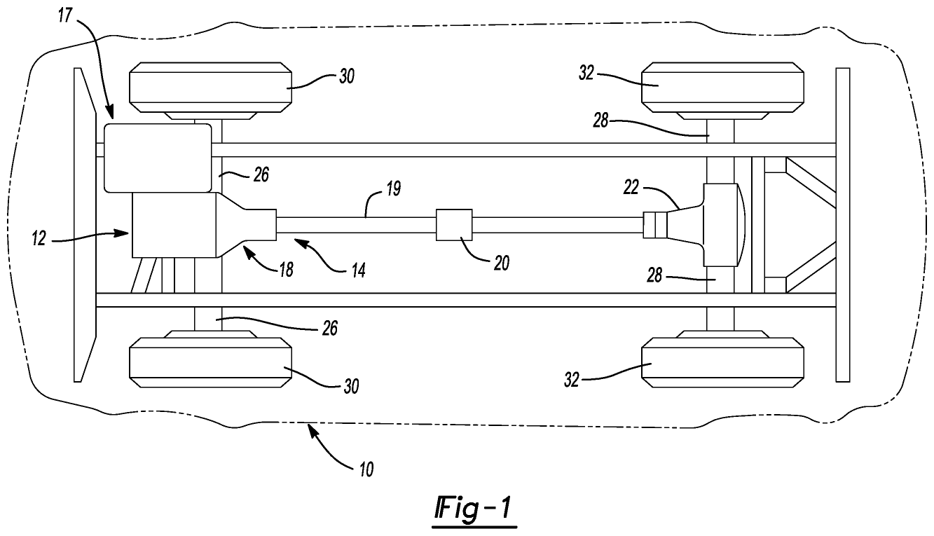

With reference to FIG. 1, a vehicle 10 is provided that includes a powertrain system 12 and a drivetrain system 14. The systems 12, 14 can be conventional systems, for example. In the particular configuration shown in FIG. 1, the powertrain system 12 includes, inter alia, an engine 17 and a transmission 18. The drivetrain system 14 includes, inter alia, a propeller shaft 19, a center differential 20, a rear differential 22 and a pair of front and rear shafts or axles 26, 28. Rotary power generated by the powertrain system 12 is transmitted to the drivetrain system 14. That is, rotatory power generated by the powertrain system 12 is transmitted to the pair of front axles 26 to drive a set of front wheels 30. Similarly, rotatory power generated by the powertrain system 12 is transmitted to the pair of rear axles 28 (via the propeller shaft 19, the center differential 20 and the rear differential 22) to drive a set of rear wheels 32.

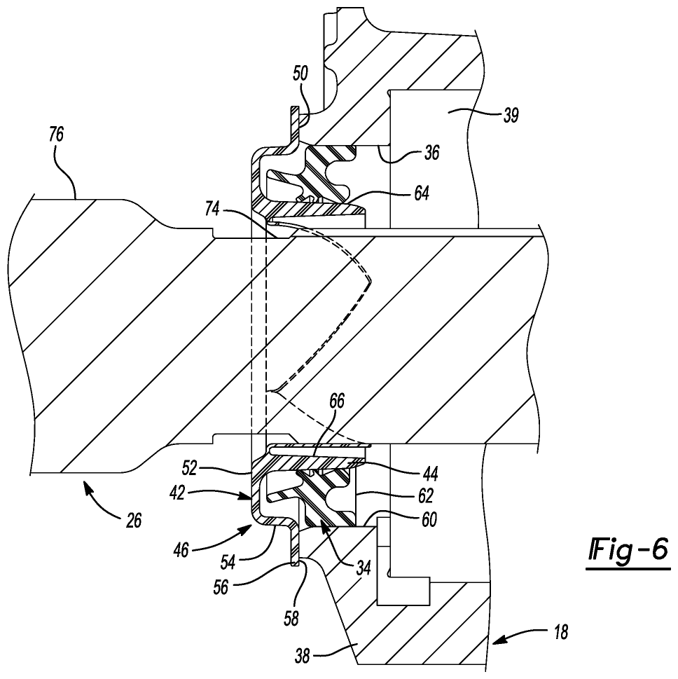

As shown in FIGS. 6-8, an annular sealing member 34 is made of a resiliently compressible material and is installed within a respective opening 36 of a casing 38 of the transmission 18. In this way, when each axle 26 of the pair of front axles 26 is assembled to the transmission 18, the sealing members 34 (only one shown in the figures) seal against a respective axle 26 to prevent fluid (i.e., transmission fluid) in a cavity 39 of the casing 38 from leaking out.

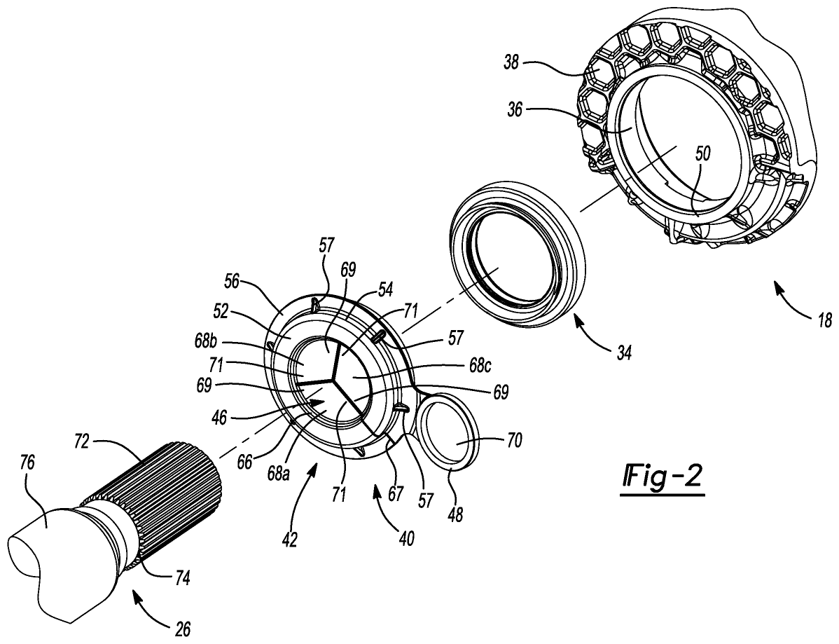

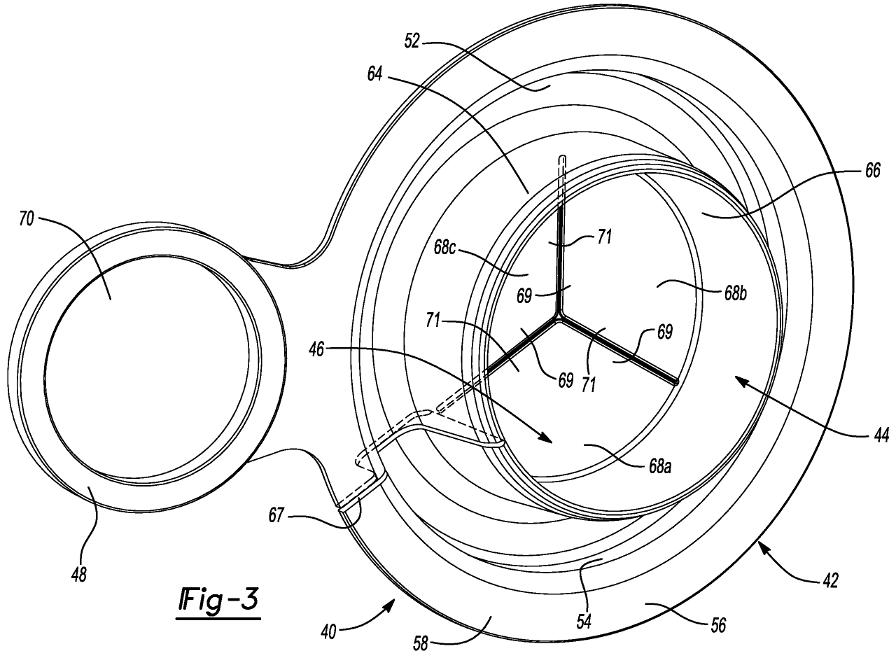

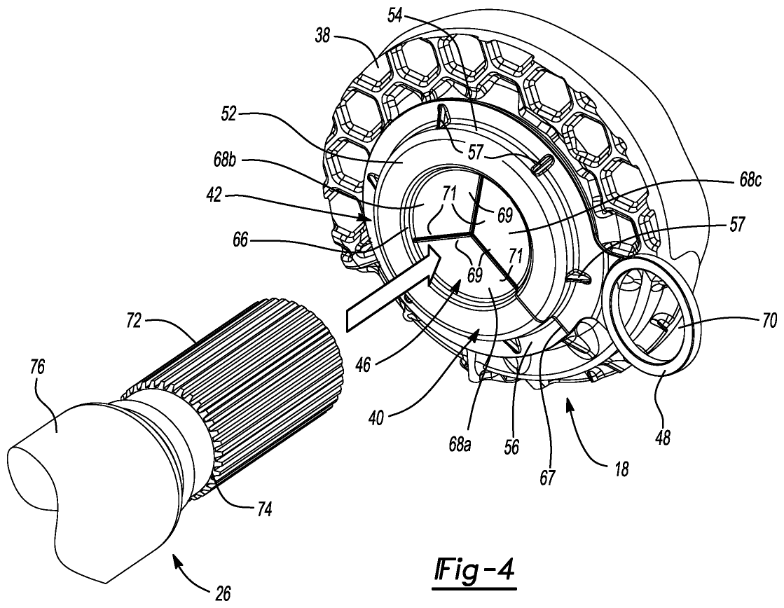

With reference to FIGS. 2-7, a cap 40 is removably coupled to the casing 38 such that the cap 40 plugs the respective opening 36 of the casing 38 (FIGS. 4-6). In this way, the cap 40 prevents fluids and debris from entering into the cavity 39 of the casing 38 and also prevents fluid in the cavity 39 of the casing 38 from leaking out. The cap 40 is made of a resiliently compressible material and includes a rim portion 42, a hub 44, a membrane portion 46 and a handle 48. In some configurations, the cap 40 is made of a polymeric material or any other suitable material.

The rim portion 42 extends 360 degrees around an axial end of the hub 44 and contacts an outer surface 50 of the casing 38 (FIG. 6). The rim portion 42 includes an inner member 52, an intermediate member 54 and an outer member 56. The inner member 52 extends from the axial end of the hub 44 in a radial direction (i.e., the inner member 52 extends perpendicular to a longitudinal axis of the axles 26). The inner member 52 also extends parallel to the outer member 56 and perpendicular to the intermediate member 54. The intermediate member 54 extends from an end of the inner member 52 in an axial direction (i.e., the intermediate member 54 extends parallel to the longitudinal axis of the axles 26). The outer member 56 extends from an end of the intermediate member 54 in a radial direction. A plurality of attachment members 57 are integral with the intermediate member 54 and the outer member 56 to strengthen attachment of the intermediate member 54 and the outer member 56 to each other. As shown in FIG. 6, a surface 58 of the outer member 56 contacts the outer surface 50 of the casing 38. As shown in FIG. 6, the hub 44, the inner member 52, the intermediate member 54 and a wall 60 of the opening 36 cooperate to form a space 62 that the sealing member 34 is positioned in when the cap 40 is coupled to the casing 38.

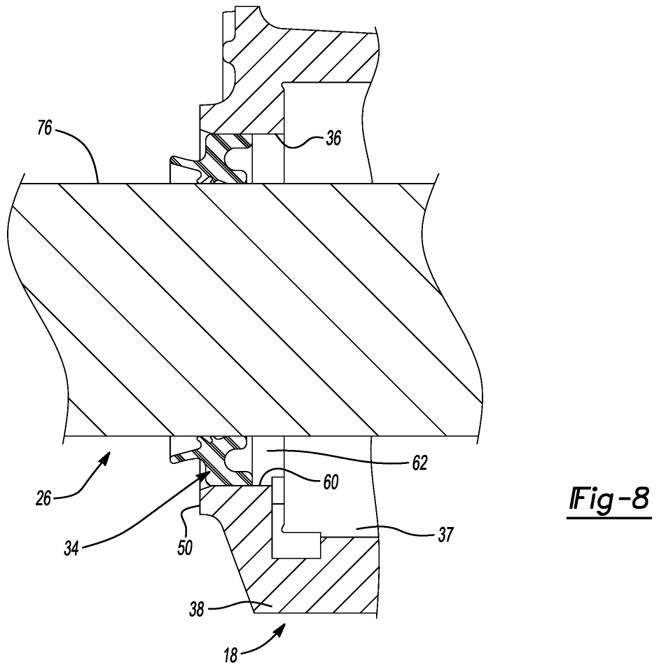

The hub 44 is disposed within the opening 36 and extends toward the cavity 39 of the casing 38. The sealing member 34 is disposed between the hub 44 and the wall 60 such that a portion of the sealing member 34 sealingly engages an outer diametrical surface 64 of the hub 44 and another portion of the sealing member 34 sealingly engages the wall 60 of the opening 36 (FIG. 8). The hub 44 also surrounds or covers the membrane portion 46. A slit 67 is formed in the rim portion 42 and the hub 44 so that the cap 40 can be removed from the casing 38 after the axle 26 is assembled to the transmission 18.

As shown in FIGS. 2-4, the membrane portion 46 is circular-shaped and extends from an inner diametrical surface 66 of the hub 44 at or near an axial end thereof. The membrane portion 46 has a thickness that is thinner than a thickness of the rim portion 42 and the hub 44. The membrane portion 46 is comprised of a plurality of triangular-shaped flexible tabs 68a, 68b, 68c that extend from the inner diametrical surface 66 of the hub 44. Each tab 68a, 68b, 68c includes end portions 69, 71 that are attached to end portions 69, 71 of a respective tab 68a, 68b, 68c. For example, one end portion 69 of the tab 68a is attached to the end portion 71 of the tab 68b while the other end portion 71 of the tab 68a is attached to the end portion 69 of the tab 68c. The membrane portion 46 is configured to be punctured when enough force is applied thereto such that the tabs 68a, 68b, 68c detach from one another. The handle 48 extends from the outer member 56 of the rim portion 42 and includes an opening 70. An installer (not shown) can grip the handle 48 to remove the cap 40 from the casing 38.

With continued reference to FIGS. 1-8, a method for assembling the front pair of axles 26 to the transmission 18 using the cap 40 will now be described in detail. It should be understood that although the method will describe in detail the assembly of one of the front pair of axles 26 to the transmission 18, the other axle 26 of the front pair of axles 26 can be assembled to the transmission 18 using the same or a similar method.

First, as shown in FIG. 4, the cap 40 is coupled to the casing 38 such that the cap 40 plugs the respective opening 36 of the casing 38. In this way, the cap 40 prevents fluids and debris from entering into the cavity 39 of the casing 38 and also prevents fluid in the cavity 39 of the casing 38 from leaking out when the transmission 18 is shipped to an assembly plant, for example.

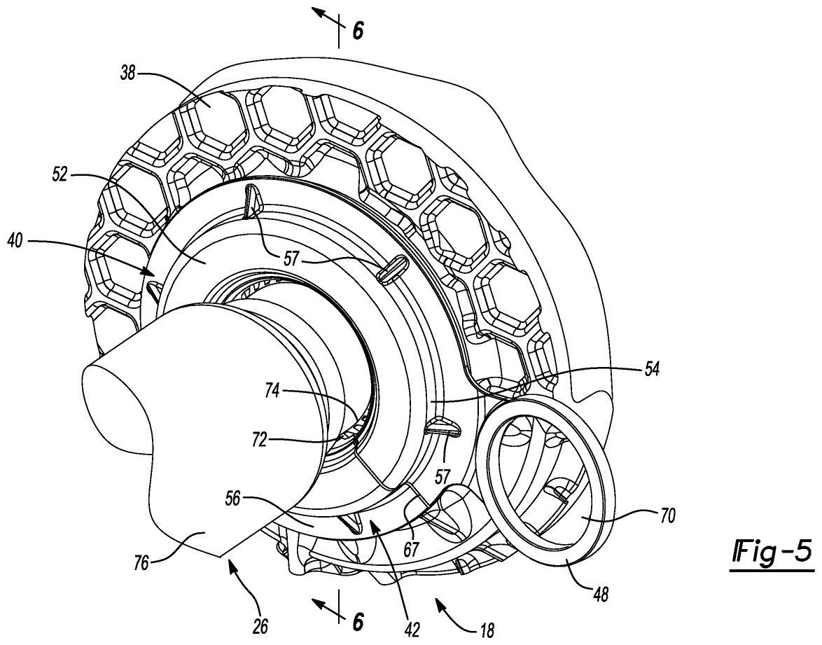

Next, as shown in FIGS. 5 and 6, the axle 26 is assembled to the transmission 18. That is, the axle 26 is inserted through the hub 44, the membrane portion 46 and through the opening 36 of the casing 38 until teeth 72 that are formed on an outer diametrical surface 74 of the axle 26 at an end thereof engage a gear set (not shown) disposed within the casing 38. The force applied to the membrane portion 46 when inserting the axle 26 through the hub 44, the membrane portion 46 and the opening 36 causes the membrane portion 46 to puncture (i.e., causes the plurality of tabs 68, 68b, 68c to detach from one another). When the tabs 68a, 68b, 68c detach from one another, each tab 68a, 68b, 68c slides along the axle 26 as it is being assembled to the transmission 18.

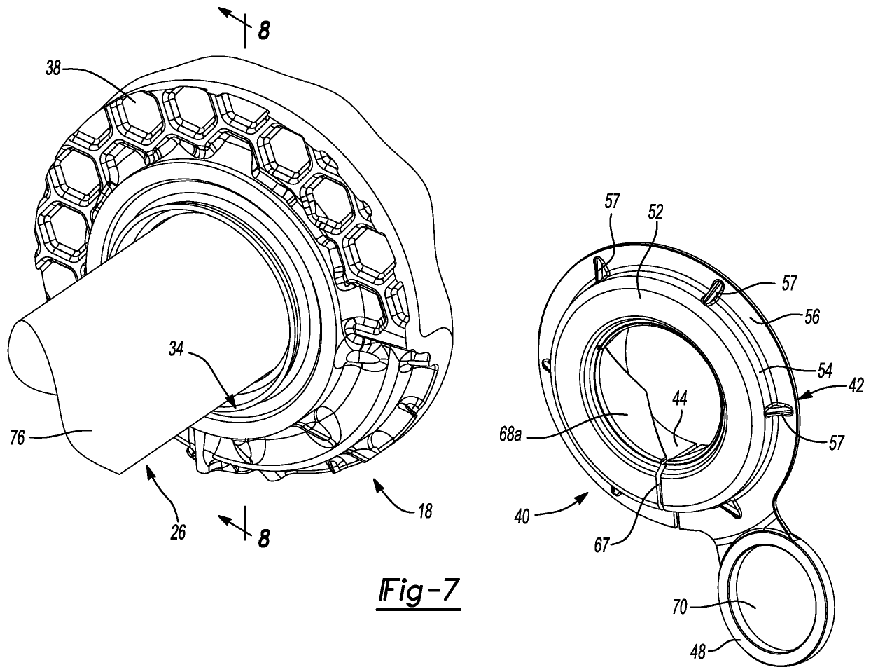

Finally, as shown in FIGS. 7 and 8, the cap 40 is removed from the casing 38. That is, after the axle 26 is assembled to the transmission 18 (i.e., after the axle 26 has been inserted through the hub 44, the membrane portion 46 and the opening 36 such that the teeth 72 of the axle 26 engage the gear set (not shown) of the casing 38), the installer will grip the handle 48 to remove the cap 40 from the casing 38. Once the cap 40 is removed from the casing 38, the sealing member 34 will sealingly engage an outer diametrical surface 76 of the axle 26 (FIG. 8) to prevent fluids and debris from entering into the cavity 39 of the casing 38 and also to prevent fluid in the cavity 39 of the casing 38 from leaking out.

The cap 40 of the present disclosure provides the benefit of preventing damage to the sealing member 34 when assembling the axles 26 to the transmission 18. That is, the cap 40 protects the sealing members 34 as the axles 26 are being assembled to the transmission 18. The cap 40 of the present disclosure also provides the benefit of preventing fluids and debris from entering into the cavity 39 of the casing 38 and preventing fluid in the cavity 39 of the casing 38 from leaking out.

Although the cap 40 is described above as being used to assemble the front axles 26 to the transmission 18, the cap 40 can also be used to assemble other components of the vehicle 10 to each other. For example, the cap 40 of the present disclosure can be used to assemble the rear axles 28 to the rear differential 22. That is, the cap 40 can be used to removably plug an opening of a differential case, a transfer case, or any other component having an opening through which a shaft is inserted during assembly of the vehicle or vehicle sub-system.

While the vehicle 10 in FIG. 1 is shown and described as being an all-wheel-drive (AWD) vehicle, the teachings of the present disclosure can be used in any type of vehicle (e.g., in a front-wheel-drive (FWD) vehicle, a rear-wheel-drive (RWD) vehicle, a four-wheel-drive (4WD) vehicle, etc.).

What is claimed is:

1. A vehicle component comprising:
a casing defining an opening; and
a cap removably coupled to the casing such that the cap plugs the opening, the cap including a membrane portion and a rim portion extending around the membrane portion,
wherein the cap is configured to be removed from the casing after a shaft is inserted through the membrane portion and at least partially through the opening.

2. The vehicle component of claim 1, wherein the casing is a transmission casing.

3. The vehicle component of claim 1, wherein a sealing member is disposed between the cap and the casing.

4. The vehicle component of claim 1, wherein the casing includes a cavity having fluid therein, and wherein the cap includes a hub extending from the rim portion toward the cavity.

5. The vehicle component of claim 4, wherein the rim portion and the hub includes a slit formed therein.

6. The vehicle component of claim 5, wherein the hub surrounds the membrane portion.

7. The vehicle component of claim 6, wherein a sealing member is disposed between the hub and the casing.

8. The vehicle component of claim 1, wherein the membrane portion includes a plurality of flexible tabs that are attached to each other prior to the shaft being inserted through the membrane portion and detached from each other after the shaft is inserted through the membrane portion.

9. The vehicle component of claim 1, wherein the rim portion includes slit formed therein.

10. The vehicle component of claim 1, wherein the cap includes a handle extending from the rim portion.

11. A method for assembling a shaft to a vehicle component, the method comprising:
plugging an opening of the vehicle component with a cap, the cap including a membrane portion and a rim portion extending around the membrane portion;
inserting the shaft through the membrane portion and at least partially through the opening; and
removing the cap from the vehicle component after the shaft is inserted through the membrane portion and at least partially through the opening.

12. The method of claim 11, wherein the vehicle component includes a cavity having fluid therein, and wherein the cap includes a hub extending from the rim portion toward the cavity.

13. The method of claim 12, wherein removing the cap from the vehicle component includes ripping the cap across the shaft.

14. The method of claim 12, wherein the rim portion and the hub includes a slit formed therein.

15. The method of claim 14, wherein a sealing member is disposed between the hub and the vehicle component prior to the cap being removed from the vehicle component.

16. The method of claim 11, wherein the membrane portion includes a plurality of flexible tabs that are attached to each other prior to the shaft being inserted through the membrane portion and detached from each other after the shaft is inserted through the membrane portion.

17. The method of claim 11, wherein the vehicle component is a transmission.

18. The method of claim 11, wherein a sealing member is disposed between the cap and the vehicle component prior to the cap being removed from the vehicle component.

19. The method of claim 11, wherein the cap includes a handle extending from the rim portion.
